(19) United States
(12) Patent Application Publication
(10) Pub. No.: US 2015/0127916 A1
(43) Pub. Date: May 7, 2015

(54) DYNAMIC MEMORY ALLOCATION

(71) Applicant: Toshimitsu Kani, Windsor, CO (US)

(72) Inventor: Toshimitsu Kani, Windsor, CO (US)

(73) Assignee: Hewlett-Packard Development Company, L.P., Houston, TX (US)

(21) Appl. No.: 14/396,383

(22) PCT Filed: Apr. 25, 2012
(86) PCT No.: PCT/US2012/034891

§ 371 Date: Oct. 23, 2014

(51) Int. Cl. G06F 3/06

(52) U.S. Cl. CPC G06F 3/061; G06F 3/0644; G06F 3/067
USPC 711/153

(57) ABSTRACT

A method includes calling a function of a memory class object to cause access to a value in a memory table of the memory class object so as to dynamically allocate a memory for access by an operating system. The memory class object represents the memory. The value corresponds to a property of a memory slice selected from a plurality of memory slices into which the memory is partitioned.

### BACKGROUND

A computer system environment may be designed to enable a plurality of users to share hardware and software resources. Shared hardware resources may include, for example, printers or other output devices, data storage and memory devices, and computer processing resources. A host machine and its operating system may manage the shared resources. A user in such an environment may be provided with access to a subset of the environment that is herein referred to as a virtual machine. A virtual machine emulates a separate machine environment (e.g. processor) that is assigned to a guest operating system. (A virtual machine may, in turn, be shared by multiple users, e.g. that remotely log in to the virtual machine.) In such an environment, a user that interacts with a virtual machine is not aware of any activity that takes place on any other virtual machine that shares the same hardware. For example, a computer memory that is accessible by several virtual machines may be partitioned such that each virtual machine has exclusive access to a different portion of the computer memory. A user of one virtual machine may store data in its assigned portion of the computer memory that is not accessible by a user of a different virtual machine. Thus, each user may interact with a virtual machine in the same manner as one would with a separate physical machine.

A networked computer system environment may be configured to enable a virtual machine or guest operating system to migrate from one system or host to another. During migration, functionality of virtual machine may be transferred from one hardware device to another. The migration may occur without perceptible interruption of operation of the virtual.

Devices in a computing environment may be configured in accordance with a standard such as the Advanced Configuration and Power Interface (ACPI) specification. With such a standard, each device in the environment is represented under an operating system as an object. An object that represents a device includes a hardware identifier (HID) that identifies a type of device. Each object also includes a unique identifier (UID) that is assigned uniquely to a single device (which may share an HID). An object also may include methods. For example, a status method may return a current status of a device (e.g. enabled or disabled). An object may include one or more device-specific methods that are specific to a particular type of device.

A system may be configured to enable connecting or disconnecting a device while the system is running. Such a capability is variously referred to as hot plugging or unplugging, or as dynamic addition or deletion. For example, to enable disconnecting a device when the system is running, an object that corresponds to the device under ACPI may be provided with an eject method.

### BRIEF DESCRIPTION OF THE DRAWINGS

Examples described herein may best be understood by reference to the following detailed description when read with the accompanied drawings in which:

FIG. 1 is a schematic illustration of a system for application of an example of dynamic allocation of memory resources;

FIG. 2 is a schematic illustration of organization of the computer system shown in FIG. 1; and

FIG. 3 is a flowchart depicting an example of a method for dynamic allocation of memory resources.

### DETAILED DESCRIPTION

In accordance with examples of dynamic allocation of memory resources, a portion of a memory device may be accessible by an operating system, e.g. of a virtual machine. The memory device system may be treated by the operating system as a partitioned memory that is partitioned into a plurality of divisions. The divisions are herein referred to as memory slices. Some of the memory slices may be accessible by the operating system while others are not. The partitioned memory device may be partitioned into contiguous memory slices of equal size, or may be partitioned into arbitrarily sized contiguous memory slices. A single operating system may be granted access to some or all of the memory slices, which may not be contiguous with respect to one another.

Dynamic allocation (“hot plugging or unplugging”) of memory resources refers to a capability to modify accessibility to a memory slice by an operating system during operation of the machine (e.g. virtual machine) on which the operating system is running. For example, during operation of the operating system, one or more additional memory slices may be added (access enabled) or deleted (access disabled).

In a system lacking a capability for dynamic allocation, memory resources would be allocated only when a machine were to be started or restarted. Any change in allocation would require restarting the virtual machine.

Advantages of dynamic allocation of memory resources may be understood (and are herein described) within the context of a system that is capable of supporting a plurality of virtual machines that share memory resources. However, examples of dynamic allocation of memory resources may be implemented on a single physical machine or processor running a single operating system, or on any computing machine, computer, or processor that utilizes access to memory.

For example, in accordance with examples of dynamic allocation of memory resources, a memory device may be incorporated into, or otherwise associated with or accessible by, a host system. A “host system” (also referred to as a virtual machine manager or “hypervisor” system) herein refers to a machine (e.g. a computer or processor) that provides resources to one or more virtual machines (e.g. virtual computers or processors). The memory device of the host system may thus be made available to one or more virtual machines that are running as guest systems on the host system. A virtual machine may be accessible by a user device (e.g. a network terminal) that is located at a location that is remote from the host system. For example, the user device may be configured to communicate with the host system via a network (to be understood as including any wired or wireless communications medium that is capable of transmitting data).

The virtual machine may operate under a configuration specification such as Advanced Configuration and Power Interface (ACPI) specification. ACPI firmware may be incorporated into the resources that are made available to each virtual machine. The partitioned memory device may be represented under ACPI (used herein as representative of any object-based specification for configuration or resource management) as a single object that is referred to herein as a memory class device object. The memory class object includes information regarding available memory slices (memory address ranges within the memory device) that are available to the virtual machine. The memory class object may be characterized by a single hardware identifier (HID) that identifies the corresponding hardware device as a memory device capable of partitioning into memory slices. In addition, the memory class object may be characterized by a single unique identifier (UID). The memory class object may include a memory slice table (which may refer to a set of structures, objects, or array variables) or similar listing that defines each available memory slice (e.g. by an address and size). An available memory slice may be characterized by a value of in the memory slice table that corresponds to a property of that memory slice. For example, the value may indicate whether that memory slice is enabled, and thus accessible to the virtual machine for data storage, or disabled and thus inaccessible by the virtual machine.

The memory class object includes functions or methods that enable the memory device to operate, including online addition and deletion of available memory slices. For example, such functions may include functions for returning memory slice information and for setting or changing a status of a memory slice (e.g. changing the status to disabled so as to effectively eject the memory slice, making the memory slice inaccessible to a virtual machine). A processor of a virtual machine may call one or more functions of the memory class object in order to determine a status of one or more memory slices, or to cause change a status (e.g. dynamically add or delete) of a memory slice (e.g. by requesting a host system to change the status). A function that accesses (e.g. reads or modifies) or causes a host system or guest operating system to access a value in a memory slice table is herein referred to as causing access to the value.

Examples of dynamic allocation of memory resources as described herein may be advantageous over other techniques used for allocation of memory resources. Dynamic memory allocation as described herein may enable division of a memory of any size into arbitrarily small memory slices. Access to and reading of a memory slice table of a single memory class object may enable relatively rapid and efficient access to memory slices (e.g. as opposed to accessing a similar number of separate objects). Thus, an arbitrary number of memory slices may be efficiently managed, enabling dynamic addition or deletion (hot plugging or unplugging) of small memory slices. The ability to reduce the size of the memory slices into which a memory device is partitioned may increase flexibility and efficiency of a system. With small memory slices, the amount of memory that is allocated or reallocated may be more closely matched to the needs of the each virtual machine.

Examples of dynamic allocation of memory resources as described herein may be advantageous when a virtual machine migrates from one host system to another. For example, when migrating, the accessible memory resources (e.g. partitioned into one megabyte slices) may be transferred from a smaller (e.g. one gigabyte) memory device to a larger (e.g. one terabyte) memory device. After such a migration, the virtual system may be capable of accessing the entire larger memory device by appropriately modifying the memory slice table of a memory class object of the guest operating system.

Allocation of small memory slices as described herein may be more efficient at handling small memory slices than some previously described techniques in which each partition or slice of the memory device would be associated with a separate object under ACPI. Typically, the amount of time and resources required to access a large number of separate objects would be much larger than the amount of time required to access a similarly large number of entries in a memory slice table of a single memory class object. In such a previously-described system, for example, the example of migration of memory resources (while retaining a one-megabyte slice size) from a one-gigabyte memory device to a one-terabyte memory device would require an increase in the required number of separate objects associated with memory slices from 1024 to 1024². Such an increase in the number of objects could significantly reduce the speed of operation of such a system. If, on the other hand, if the size of each memory slice were to be increased (e.g. to one gigabyte that the number of memory slices remain at 1024), flexibility of the system in reallocating memory resources would be impaired or reconfiguring the guest operating system would be required.

A system may be configured for application of an example of dynamic allocation of memory resources.

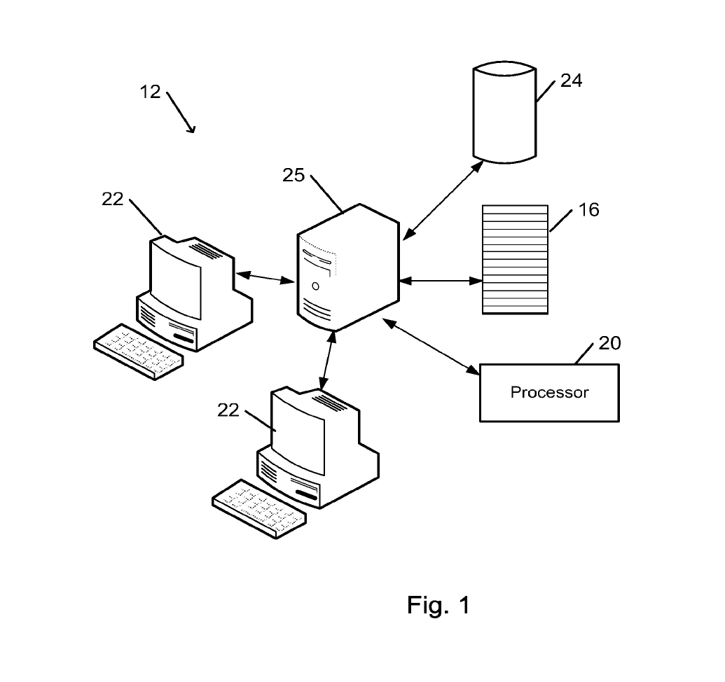

FIG. 1 is a schematic illustration of a system for application of an example of dynamic allocation of memory resources.

Computer system 12 may represent one or more intercommunicating computers or servers that may be located at various locations that may be remote from one another. Computer system 12 may include, be associated with, or communicate with, one or more devices or other resources that may be managed by a host system 25 and made available to one or more virtual machines 22. For example, the resources may include a processor 20, a memory 16, or data storage device 24. Various regions of shared memory 16 may be accessed by different guest operating systems of different virtual machines 22.

A virtual machine 22 may be accessible from a remote location, e.g. by a remote terminal or other device that communicates with computer system 12 via a network. For example, user operating a remote terminal may log into a virtual machine 22 via the network. Such a terminal include one or more of a processor, an input device (e.g. keyboard, keypad, pointing device, control, microphone), an output device (e.g. computer monitor or screen, printer, display panel, speaker, or another device capable of producing visible, audible, or tactile output), data storage device, or memory device.

Computer system 12 may be operated to provide resources, such as memory resources, for access by one or more virtual machines 22. Computer system 12 may be configured to enable dynamic allocation of memory resources. Computer system 12 may be configured to run a host system 25 or virtual machine manager that allocates hardware resources to one or more virtual machines running under guest operating systems. For example, a virtual machine manager may determine that a region of shared memory 16, being accessible by one virtual machine, is to be characterized as unavailable to all other virtual machines that share memory resources of shared memory 16.

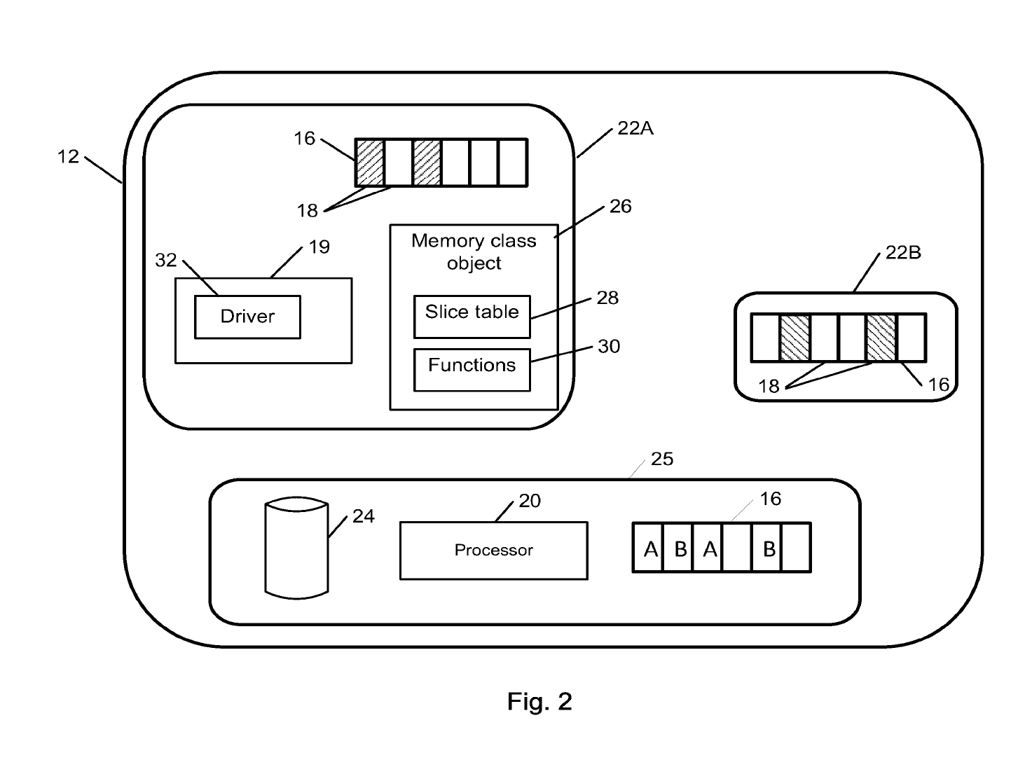

FIG. 2 is a schematic illustration of organization of the computer system shown in FIG. 1. One or more components of computer system 12 may be incorporated into, or connected to, one or more intercommunicating machines.

Computer system 12 is configured for operation of host system 25 and of virtual machines 22A and 22B (for the sake of clarity, only two virtual machines are illustrated and only virtual machine 22A is illustrated in detail). Host system 25 and virtual machines 22A and 22B may run on processor 20 of computer system 12.

Host system 25 is configured to manage resources of computer system 12 and to enable access to the resources by virtual machines 22A and 22B. Resources that are managed by host system 25 may include processor 20, memory 16, and data storage device 24.

Processor 20 may include one or more processing units, e.g. of one or more computers. Processor 20 may be configured to operate in accordance with programmed instructions stored in memory 16. Processor 20 may be capable of executing an application for enabling dynamic allocation of memory resources.

Processor 20 may execute a virtual machine manager application to enable operation of host system 25.

Processor 20 may communicate with data storage device 24. Data storage device 24 may include one or more fixed or removable nonvolatile data storage devices. For example, data storage device 24 may include a computer readable medium for storing program instructions for operation of processor 20. For example, the programmed instructions may include a driver 32 for enabling dynamic allocation of memory resources as described herein. For example, driver 32 may be operated under a guest operating system 19 of a virtual machine 22A. It is noted that data storage device 24 may be remote from processor 20. In such cases data storage device 24 may be a storage device of a remote server that stores programmed instructions in the form of an installation package or packages that can be downloaded and installed for execution by processor 20. Data storage device 24 may be utilized to store data or parameters for use by processor 20 during operation, or results of operation of processor 20.

Processor 20 may communicate with memory 16. Memory 16 may include one or more volatile or nonvolatile memory devices that are accessible by processor 20. Memory 16 may be utilized to store, for example, programmed instructions for operation of processor 20, data or parameters for use by processor 20 during operation, or results of operation of processor 20. For example, memory 16 may be utilized to store programmed instructions for a guest operating system 19 of virtual machine 22A, a driver 32 to enable dynamic allocation of memory resources, or a host system 25.

At least of portion of memory 16 may be made available to a virtual machine 22A or 22B. The available portion of memory 16 may include a shared memory 16 that is partitioned into memory slices 18.

For example, memory 16 may be partitioned under virtual machine 22A or 22B into a plurality of memory slices 18. For example, each memory slice 18 may represent a functionally contiguous region of (e.g. adjacent addresses in) of shared memory 16. Memory slices 18 may be of equal size, or may vary in size. (Although memory slices 18 of memory 16 are shown as being of equal size in both virtual machine 22A and in virtual machine 22B, each guest operating system 19 may partition memory 16 differently.)

Memory slices 18 of memory 16 that are enabled for access by virtual machine 22A are indicated by shading within virtual machine 22A. Similarly, memory slices 18 of memory 16 that are enabled for access by virtual machine 22B are indicated by shading within virtual machine 22B. Within host system 25, the regions of memory 16 that are enabled for access by either virtual machine 22A or by virtual machine 22B are indicated by the letters A or B, respectively.

Guest operating system 19 may include a memory class object 26. Memory class object 26 may be available to virtual machine 22A (and may reside in a virtual processor of virtual machine 22A).

A memory class object 26 may include, for example, an HID, a UID, and an indication of a status (e.g. memory 16 being available or not available). The HID may be unique to a memory device that is compatible with dynamic allocation of memory resources via a memory class object 26 as described herein. A memory class object 26 may also include information to enable compatibility with a guest operating system 19 that is not configured to interact with a memory class object 26. For example, such a guest operating system 19 may not include driver 32 that enables dynamic allocation of memory resources via memory class object 26. Such information to enable compatibility may include, for example, a compatible identifier (CID).

For example, a guest operating system may include a in which the driver that is incompatible with dynamic memory allocation. In this case, the HID (which is checked before the CID) may not be recognized. The CID (which is checked when the HID is not recognized) may be interpreted to treat memory class object 26 as an object that represents a memory device. A resource table identifies (statically) available regions of the memory device (the resource table being ignored if HID is recognized by driver 32 of guest operating system 19). As another example, a guest operating system may include a driver that enables dynamic memory allocation by representing each memory slice by a separate object, each slice being defined by a separate resource table. In this case, the CID may be interpreted so to treat memory class object 26 as representing a memory device (whose range is determined by the resource table). However, since memory class object 26 lacks a standard eject operation for disconnecting the memory device, the memory device is treated as not ejectable and is protected from any attempt to eject it.

Memory class object 26 includes a memory slice table 28. Memory slice table 28 may include a listing or enumeration of memory slices 18 (e.g. as an array of objects). For example, each memory slice 18 may be represented in memory slice table 28 as a set of flags, variables, or parameters. The variables may indicate properties of a corresponding memory slice 18. Such variables may include, for example, a location in shared memory 16 of each memory slice 18 (e.g. as a starting address and an ending address, or as an address and a size), and a status of each memory slice 18 with regard to virtual machine 22A.

Memory class object 26 includes one or more functions 30. A function 30 may be called by a guest operating system 19 under which virtual machine 22A is running (different virtual machines, such as virtual machines 22A and 22B may run under different operating systems). In some cases, calling a function 30 may return a value that indicates a property of one or more memory slices 18. For example, the returned value may be a current value of a variable that indicates a property of a memory slice 18. In other cases, calling a function may modify a property of a memory slice 18. For example, calling the function may modify a value of a variable that determines a properly of a memory slice 18.

For example, functions 30 may include a function that returns a representation of memory slice table 28 when called by a guest operating system 19. The representation may include a number of listed representations of memory slices. The representation of memory slice table 28 may include for each memory slice 18: a universal unique identifier (UUID) , an indication of a status (e.g. enabled or available, or disabled or not available), a starting (minimum base) address, a length (e.g. in terms of memory units or addresses), or an eject status (e.g. whether the slice is to be ejected). (The UUID may be treated under guest operating system 19 as being interchangeable with a UID, e.g. as of an object that represents an individual memory slice.)

Functions 30 may include a function that may be called by a guest operating system 19 when dynamically adding (making accessible to virtual machine 22A that is running under guest operating system 19) one or more memory slices 18 (e.g. each identified by its UUID) that guest operating system 19 requests (e.g. from host system 25) to add. For example, such a function may return an updated representation of memory slice table 28 that includes the added memory slices.

Functions 30 may include a function that may be called by a guest operating system 19 when dynamically deleting (making inaccessible to virtual machine 22A that is running under guest operating system 19) one or more memory slices 18 (e.g. each identified by its UUID) that guest operating system 19 requests (e.g. from host system 25) to delete. Such a function may ensure that any data that is stored on the memory slice 18 to be deleted is moved to another, accessible memory slice 18 by guest operating system 19 before the requested memory slice is ejected. The function may return a list of the slices that are to be deleted (e.g. each identified by its UUID).

Functions 30 may include a function that may be called by a guest operating system 19 to eject (dynamically delete) one or more memory slices 18 (e.g. each identified by its UUID). An ejected memory slice 18 is no longer accessible by virtual machine 22A that is running under guest operating system 19. For example, a variable or flag may be modified in memory table 28 of memory class object 26 to indicate that the ejected memory slice 18 is not accessible by virtual machine 22A. Such a function may return an indication (e.g. flag or variable) that indicates whether or not the eject operation was successful.

Functions 30 may include a function that may be called by a guest operating system 19 to mark one or more memory slices 18 (e.g. each identified by its UUID) as not ejectable. For example, a variable or flag may be modified in memory table 28 of memory class object 26 to indicate a memory slice 18 as not ejectable by virtual machine 22A. Such a function may ensure that a minimum quantity of memory remains accessible by a virtual machine 22A that is running under guest operating system 19. For example, such a minimum quantity of memory may be necessary for storing memory class object 26, a guest operating system 19, and programmed instructions that may be required for operating a virtual machine 22A or an example of an application for dynamic allocation of memory resources. For example, such a function may return an updated representation of memory slice table 28.

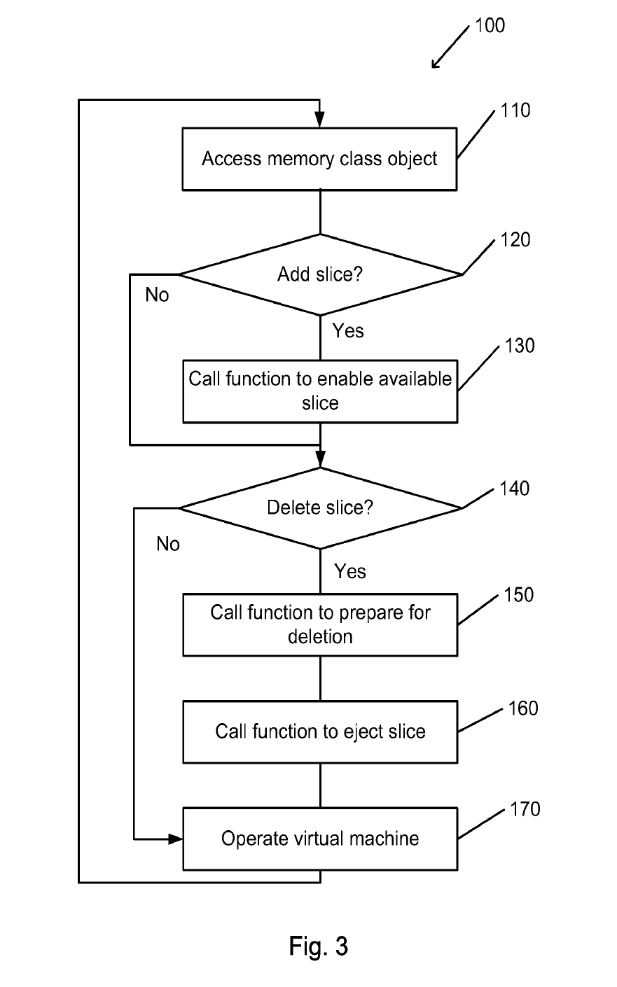

In operation, processor 20 may execute a method for dynamic allocation of memory resources. FIG. 3 is a flowchart depicting an example of a method for dynamic allocation of memory resources.

Dynamic memory allocation method 100 may be executed by a processor of a system for dynamic allocation of memory resources. For example, dynamic memory allocation method 100 may be executed by a guest operating system that is running on a virtual processor of a virtual machine. Dynamic memory allocation method 100 may be executed automatically at predetermined periodic intervals, in response to a predetermined event or situation (e.g. when booting a virtual machine, prior to performing an action that requires memory resources, upon receiving a request to increase or decrease a quantity of accessible memory resources, upon receiving an indication that a quantity of accessible memory resources is to be increased or decreased), or upon a request or command that is issued by a user or automatically issued by another application (e.g. a guest operating system of a virtual machine, or by a virtual machine manager application).

It should be understood with respect to the flowchart that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other examples of the illustrated method.

Similarly, it should be understood that, unless indicated otherwise, the illustrated order of execution of the operations represented by blocks of the flowchart has been selected for convenience and clarity only. Operations of the illustrated method may be executed in an alternative order, or concurrently, with equivalent results. Such reordering of operations of the illustrated method should be understood as representing other examples of the illustrated method.

Dynamic memory allocation method 100 includes accessing (e.g. creating or accessing a previously created) a memory class object that corresponds to a partitioned memory device (block 110). For example, the memory class object may be created by a guest operating system of a virtual machine when the virtual machine is started up (booted), or when a memory device becomes available to the virtual machine (e.g. when access to memory is required or requested, or as a result of operation of a virtual machine manager application). Once created, the memory class object may be accessed by the operating system. For example, the memory class object may be accessed when booting to get all memory slice information.

The memory class object may control access to one or more memory slices of a partitioned memory device. For example, access to a memory slice may be controlled by the operating system of the virtual machine in accordance with one or more properties of that memory slice. Properties of each memory slice may be determined by one or more component structures of the memory class object that may be collectively referred to as a memory slice table. Properties of the memory slice may be set by a virtual machine manager application or by the guest operating system. Properties of the memory slice may be ascertained, set, or modified by the guest operating system by calling an appropriate function of the memory class object.

During operation of a guest operating system of a virtual machine, the guest operating system may receive a notification to dynamically add (make accessible) a memory slice (block 120). For example, the guest operating system may receive such a notification from an application that is running on the virtual machine under the guest operating system in response to a detected requirement or request to increase a volume of accessible memory.

In response to the notification to dynamically add a memory slice (or slices), the guest operating system may call an appropriate add function of the memory class object to enable an indicated memory slice (block 130). For example, a memory slice may be selected for addition in accordance with a predetermined sequence or in accordance with other criteria (e.g. proximity to other enabled memory slices). The memory slice may be indicated by its associated UUID, address, or other indication. Calling the add function may request a host system to provide one or more enabled memory slices. As a result of calling the add function, an updated memory slice table in which one or more properties of one or more memory slices are modified may be provided so as to enable access those memory slices by the guest operating system of the virtual machine. The host system may ensure that no memory resources that are currently allocated to a different virtual machine would be added to the requesting guest operating system.

During operation of a guest operating system of a virtual machine, the guest operating system may receive a notification to dynamically delete (make inaccessible) a memory slice (block 140). For example, the guest operating system may receive such a notification from an application that is running on the virtual machine under the guest operating system in response to a detecting a surplus of available memory resources. Such a notification may be received from a virtual machine manager application, e.g. in response to a requirement for increased memory resources by another virtual machine.

In response to the notification to dynamically delete a memory slice, the guest operating system may call an appropriate delete function of the memory class object to prepare an indicated memory slice (or slices) for deletion (block 150). For example, a memory slice may be selected for deletion in accordance with a predetermined sequence or in accordance with other criteria (e.g. volume of data currently stored in each memory slice, distance from other enabled memory slices). The memory slice may be indicated by its associated UUID, address, or other indication. Calling the delete function may cause any data that is currently stored on the indicated memory slice to be copied to one or more other currently enabled memory slices, or may return a list of memory slices to be deleted, whose data content is to be moved by the guest operating system to other memory slices. Memory management techniques may be applied to determine a destination memory slice for any moved data. A list of memory slices to be deleted may be returned by the function.

The guest operating system of the virtual machine may call an appropriate eject function to eject (delete or disable) one or more memory slices that are indicated for deletion (block 160). Calling the eject function may cause one or more properties of the indicated memory slice to be modified so as to disable access to that memory slice by the guest operating system of the virtual machine. For example, a request to eject the memory slices may be made to a host system. Success of the eject operation may be determined from one or more values that are returned by the eject function.

Whether or not a memory slice is added or deleted, the virtual machine may operate, utilizing any memory slices that are allocated to the virtual machine as indicated by the accessed memory class object (block 170). The memory class object may be accessed as needed (returning to block 110).

In accordance with an example of a method for dynamic allocation of memory resources, a computer program application stored in a computer-readable medium (e.g., register memory, processor cache, RAM, ROM, hard drive, flash memory, CD ROM, magnetic media, etc.) may include code or executable instructions that when executed may instruct or cause a controller or processor to perform methods discussed herein, such as an example of a method for dynamic memory allocation. The computer-readable medium may be a non-transitory computer-readable media including all forms and types of computer-readable media except for a transitory, propagating signal.

We claim:

1. A method comprising calling a function of a memory class object to cause access to a value in a memory table of the memory class object so as to dynamically allocate a memory for access by an operating system, the memory class object representing the memory, and the value corresponding to a property of a memory slice selected from a plurality of memory slices into which the memory is partitioned.

2. The method of claim 1, wherein the operating system is an operating system of a virtual machine, and wherein the memory is configured to be shared by a plurality of virtual machines.

3. The method of claim 1, wherein the value indicates whether or not the selected memory slice is accessible by the operating system.

4. The method of claim 3, wherein calling the function to cause access to the value comprises causing a change in the value to dynamically add the selected memory slice.

5. The method of claim 3, wherein calling the function to cause access to the value comprises causing a change in the value to dynamically eject the selected memory slice.

6. The method of claim 1, wherein calling the function to cause access to the value comprises obtaining a representation of the memory table.

7. The method of claim 1, wherein calling the function to cause access to the value comprises changing the value to indicate that the selected memory slice is not ejectable.

8. The method of claim 1, wherein calling the function to cause access to the value comprises requesting a host system to provide access to the value.

9. A non-transitory computer readable storage medium having stored thereon instructions that when executed by a processor will cause the processor to perform the method of:
accessing a memory class object, the object representing a memory, the object including a memory table that includes a plurality of values, each value indicating a property of each memory slice of a corresponding plurality of memory slices of the memory, the object including a function that is callable to enable access to a value of said plurality of values;
calling the function to cause access a value of said plurality of values that corresponds to a selected memory slice of said plurality of memory slices.

10. The non-transitory computer readable storage medium of claim 9, wherein calling the function comprises causing access to the value to dynamically add the selected memory slice.

11. The non-transitory computer readable storage medium of claim 9, wherein calling the function comprises causing access to the value to dynamically eject the selected memory slice.

12. The non-transitory computer readable storage medium of claim 11, wherein the method further comprises calling a function of the memory class object to move data from the selected memory slice to another accessible memory slice prior to dynamically ejecting the selected memory slice.

13. The non-transitory computer readable storage medium of claim 9, wherein calling the function comprises accessing a representation of the memory table.

14. A system comprising:
a memory;
a processing unit in communication with a computer readable medium, wherein the computer readable medium contains a set of instructions wherein the processing unit is designed to carry out the set of instructions to:
create a memory class object that represents the memory, the object including a memory table that includes a plurality of values, each value indicating a property of each memory slice of a corresponding plurality of memory slices of the represented memory, the object including a function that is callable to enable access to a value of said plurality of values, the memory class object including a hardware identifier that identifies the memory as being partitionable into slices that are capable of dynamic allocation, and including a compatible identifier that identifies the memory as a memory;
access the memory class object;
in the event that the hardware identifier is recognizable, call the function to cause access a value of said plurality of values that corresponds to a selected memory slice of said plurality of memory slices;
in the event that the hardware identifier is not recognizable, access the compatible identifier to identify the memory.

15. The system of claim 14, wherein the processing unit is a processing unit of a host system, the host system being configured to host a plurality of virtual machines, wherein an operating system of each virtual machine is configured to carry out the set of instructions.
